(19) United States
(12) Patent Application Publication
(10) Pub. No.: US 2023/0103094 A1
(43) Pub. Date: Mar. 30, 2023

(54) ADJUSTABLE PILLOW TOP PET BED

(71) Applicant: Coop Home Goods, LLC, Pico Rivera, CA (US)

(72) Inventors: Kevin Chon, Pico Rivera, CA (US); Jin Chon, Pico Rivera, CA (US); Debbie Liu, Pico Rivera, CA (US)

(21) Appl. No.: 17/490,329

(22) Filed: Sep. 30, 2021

(51) Int. Cl. A01K 1/035

(52) U.S. Cl. CPC A01K 1/0353

(57) ABSTRACT

An adjustable comfort pet bed includes a pillow top with a pillow insert and a top cover. The pillow top is supported on a platform that includes a base and a bottom cover. The top cover is attached to the bottom cover with a zipper and may be removed to enable washing. Fill material within the pillow insert may be added or removed to tailor a firmness of the pillow top to accommodate the comfort and feeling of well-being to the family pet.

### BACKGROUND

Animals are beloved by families and great effort is often taken to comfort the family pet. Beds that are designed for a pet are not customized to the size or preference of the family pet. Cats and dogs typically spend more time sleeping than humans. For example, according to the American Kennel Club adult dogs may sleep as much as 12-13 hours a day. However even with such recognized sleeping habits and needs, pets may not have their own defined sleeping area in the home and instead sleep on furniture intended for humans. Moreover, available pet beds may be designed with little thought given to the comfort and well-being of the pet. Additionally, pet beds are not often designed for repeated washings and are subsequently disposed of when they reach a certain point of uncleanliness.

The background description provided herein is for the purpose of generally presenting a context of this disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

An adjustable comfort pet bed according to one example disclosed embodiment includes, among other possible things, a pillow top including a pillow insert and a top cover, a platform including a base and a bottom cover and a cover fastener attaching the top cover to the bottom cover.

A pillow top pet bed according to one example disclosed embodiment includes, among other possible things, a pillow top including a pillow insert and a top cover, the top cover includes a bottom opening, a platform including a base and a bottom cover, the bottom cover has a top opening, wherein the pillow top and the platform define a common outer periphery and a cover zipper disposed about a periphery of the bottom opening and the top opening for attaching the top cover to the bottom cover, wherein the zipper is inset from the common outer periphery.

A method of caring for a pillow top pet bed according to another example disclosed embodiment includes, among other possible things, removing a top cover from a bottom cover by unzipping a zipper that holds the top cover to a bottom cover, removing a pillow insert from the top cover, caring for the top cover, reinstalling the pillow insert into the top cover after completion of care and reattaching the top cover to the bottom cover by zipping the zipper.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a perspective view of an example pillow top pet bed.

FIG. 2 is a side view of the example pillow top pet bed.

FIG. 3 is another side view of the example pillow top pet bed with a zipper partially unzipped.

FIG. 4 is a bottom view of the pillow top pet bed.

FIG. 5 is a top view of the pillow top pet bed.

FIG. 6 is a top view of the pillow top pet bed with a pillow insert removed from a top cover.

FIG. 7 is a side view of the pillow insert partially open to show access to fill material.

FIG. 8 is a top view of a platform of the pillow top pet bed with the pillow insert removed and the top cover partially attached to a bottom cover.

FIG. 9 is another top view of the platform with the bottom cover partially removed from a base and the top cover partially attached to the bottom cover.

FIG. 10 is a perspective view of the base removed from the bottom cover.

### DETAILED DESCRIPTION

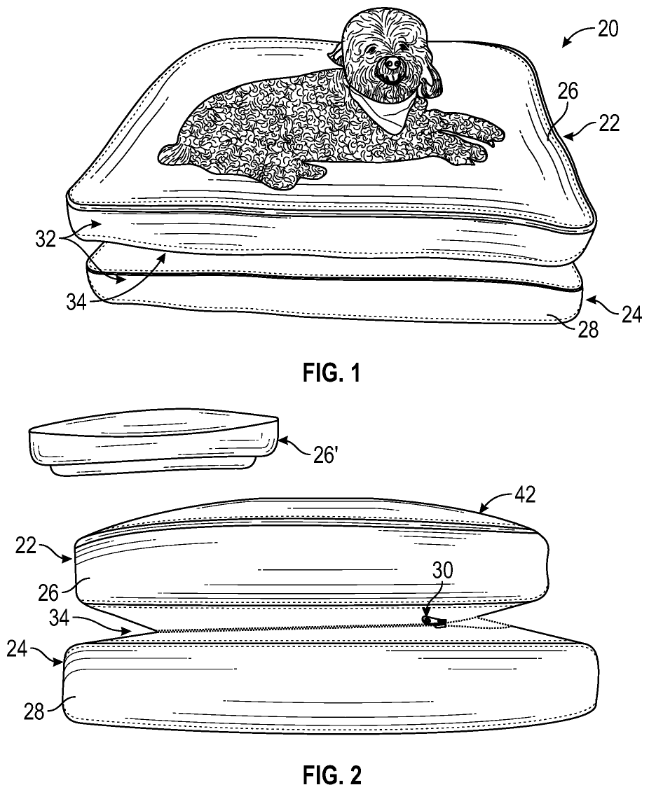

Referring to FIGS. 1 and 2, a pillow top pet bed 20 includes a pillow top 22 that is supported on a platform 24. Pets are members of the family and pet owners enjoy pampering and comforting their pet. The pillow top 22 of the pet bed 20 provides a top surface nesting area 42 for a family pet that partially envelops the pet to provide a sense of security and well-being. The pillow top 22 is filled with a cross-cut memory foam and microfiber. The amount of the fill can be changed to adjust firmness. Adjusting the pillow top 22 provides for the pet owner to customize the feel of the pet bed 20 to accommodate the pet. Accordingly, the disclosed pillow top pet bed 20 may be tailored to accommodate pets of all sizes and temperaments. Moreover, various sizes of the pet bed 20 may be provided to accommodate pets from the very large to the very small.

The pillow top 22 includes a top cover 26 that is attached to a bottom cover 28 by a cover zipper 30. The top cover 26 is removable from the bottom cover 28 by unzipping the cover zipper 30. Both the top cover 26 and the bottom cover 28 are washable and constructed from a durable long-lasting material. In this disclosed example, both the top cover 26 and the bottom cover 28 are formed from a Chenille material. Other materials may be utilized and are within the scope and contemplation of this disclosure.

The cover zipper 30 is inset as indicated at 34 from an outer periphery 32 of both the pillow top 22 and the platform 24. The inset location of the cover zipper 30 inhibits access by a family pet to prevent undesired removal. Accordingly, when in use by a pet, the cover zipper 30 is hidden between the pillow top 22 and the platform 24.

In one disclosed example, the pillow top pet bed 20 is provided with a second top cover 26′ that can be installed when the first top cover 26 is removed for cleaning. As appreciated, a pet owner may hesitate to care for the top cover 26 due to the time required for cleaning and thereby the time the family pet is without a pet bed. The second top cover 26′ is identically configured and is attached to eliminate such hesitancy. The pet owner may remove the first top cover 26 and install the second top cover 26′ such that the pet bed remains useable. The first top cover 26 may then be cleaned in due time to be ready when the second top cover 26′ requires cleaning.

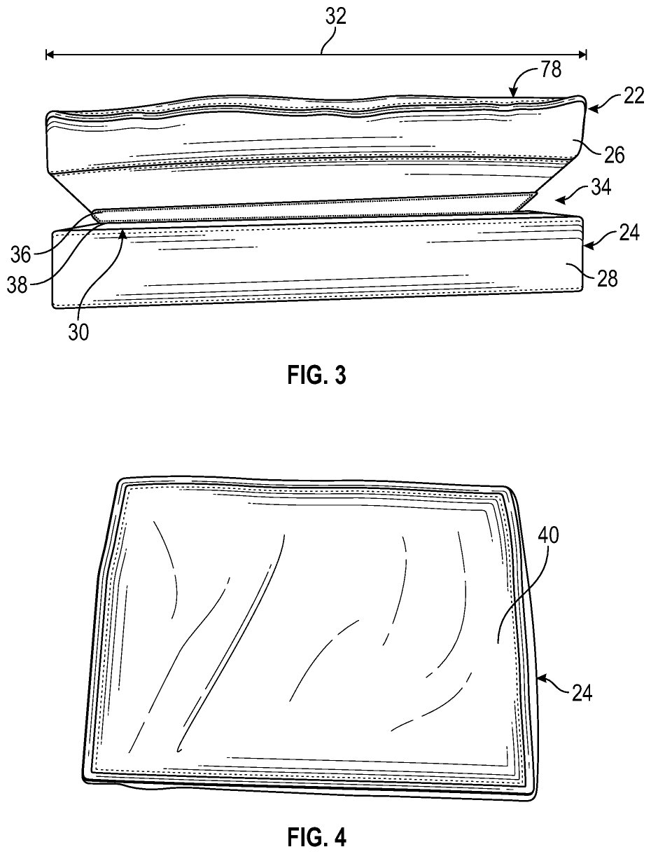

Referring to FIG. 3 with continued reference to FIGS. 1 and 2, the cover zipper 30 includes a top portion 36 that is part of the top cover 26 and a bottom portion 38 that is part of the bottom cover 28. In this example, the cover zipper 30 includes wide-toothed teeth to provide for easy assembly and actuation. In this example, a single cover zipper 30 is utilized that extends about the entire pet bed 20. However, more than one cover zipper 30 could be utilized and is within the scope of this disclosure. Moreover, other fastening devices may also be utilized within the scope and contemplation of this disclosure. For example, hook and loop type fasteners, buttons, snaps and other known material fastening devices.

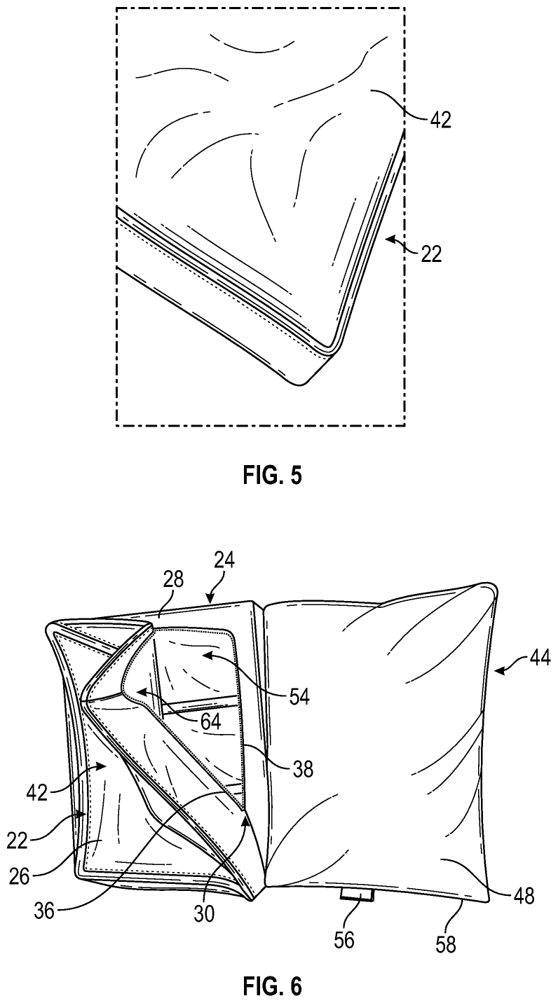

Referring to FIGS. 4 and 5 with continued reference to FIGS. 1-3, the platform 24 includes a non-skid bottom surface 40 formed from a material different than the bottom cover 28. The material for the bottom surface 40 is selected to provide durability and a non-skid surface to inhibit sliding around as the pet jumps into and out of the bed 20. The bottom surface 40 is sewn to and attached to the bottom cover 28 such that it is removable with the bottom cover 28 for washing. The pillow top 22 includes a top surface that provides a nesting area 42 for the pet and is constructed of durable breathable fabric.

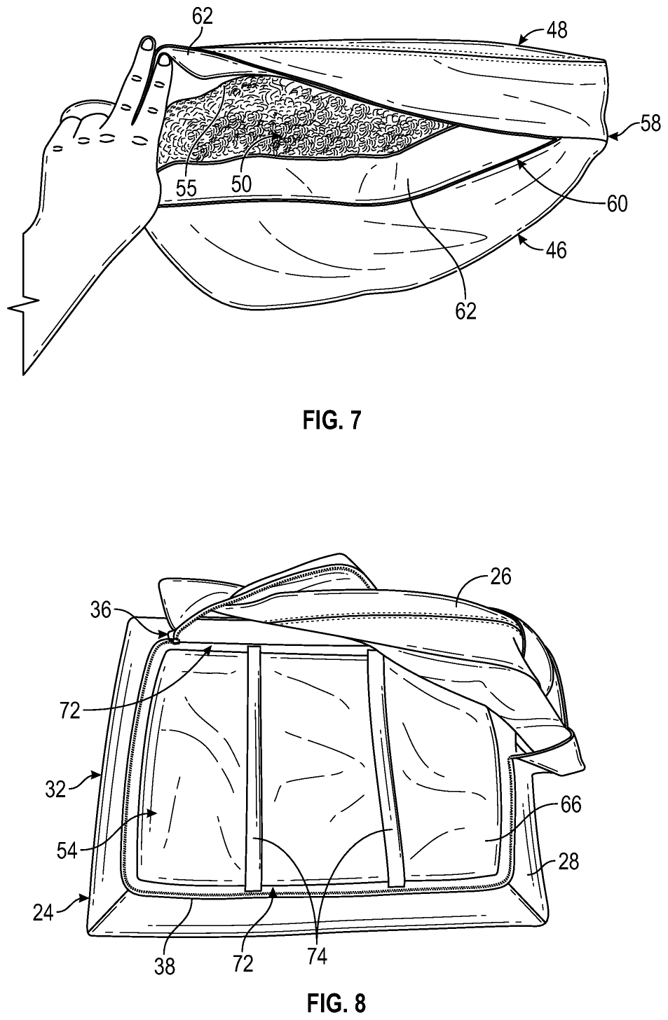

Referring to FIGS. 6 and 7 with continued reference to FIG. 3, the pillow top 22 includes a pillow insert 44 that is removable from the top cover 26. The pillow insert 44 holds the fill material 50 within an inner cavity 55. The pillow insert 44 includes a top surface 48 attached to a bottom surface 46 at a seam 58. The seam 58 is stitched to hold the top surface 48 to the bottom surface 46. An insert zipper 60 is disposed along a portion of the seam 58 to provide access to the inner cavity 55. Access to the inner cavity 55 provides for adding or removing fill material 50 to adjust a firmness of the pillow insert 44. Adjusting the amount of fill material 50 within the pillow insert 44 provides for tailoring to an individual pet based on size, temperament or any other preference considered by a pet owner.

Even the most disciplined pet may eventually soil the pet bed 20. In many prior art pet beds, once soiled, the pet owner will simply dispose of the old pet bed and obtain a new one. Even those pet beds that purport to be washable do not provide features that make it easy for the pet owner to clean. The disclosed pet bed 20 comes with a second top cover 26 so that a fresh top cover 26 can be installed while the first top cover 26 is being washed. In this way, the pet is not without a bed for any extended time. Moreover, the second top cover 26 removes any hesitancy by a pet owner in allotting time to clean the top cover 26.

Additionally, the example pillow insert 44 is formed from materials that prevent soiling of the fill material 50. The top surface 48 of the pillow insert 44 is formed from a waterproof material. In this way, any moisture that works its way through the top cover 26 does not also soil the fill material 50. In this example, the waterproof material is not simply treated, but is a permanent waterproof material. As appreciated, any waterproof treatment or coating will eventually wear away and will lose effectiveness. The protection against water intrusion also prevents air from passing through the top surface 48. Blocking of air can result in the pillow not fully compacting and conforming to the pet due to trapped air. The example insert 44 includes an air permeable bottom surface 46. The bottom surface 46 provides for air to be exhausted from the inner cavity 55 such that the pillow insert 44 will naturally contract so that the pet will rest on the fill material 50 rather than on air pockets. As appreciated, the visual appearance of the top surface 48 and the bottom surface 46 may be substantially the same. Accordingly, the disclosed the pillow insert 44 is provided with a tag 56 includes directions that indicate which side should face up and which side faces down. The tag 56 provides a visual reference that prompts the pet owner to place the waterproof top surface 48 upward against the top cover 26 and nesting area 42. In this way, any moisture that passes through the top cover 26 will encounter the waterproof portion of the pillow insert 44. The air permeable bottom surface 46 is placed against the base portion of the platform 24.

The pillow insert 44 includes zipper flange 62 within the inner cavity 55 proximate the insert zipper 60. The zipper flange 62 is a flap of nonwoven material along the length of the zipper 60 that prevents the fill material 50 from getting caught within the teeth of the zipper 60. The zipper flange 62 is attached on the zipper side free on the side away from the zipper 60 such that none of the fill material 50 interferes with operation of the zipper 60. The free side of each zipper flange 62 therefor defines a barrier that holds fill material in place and away from the zipper 60 to prevent fouling of the zipper. The example zipper 60 is defined on one side of the pillow insert 44 and is a single zipper. Further, in this example, the zipper 60 is provided on a short side of the insert 44. As appreciated, although a zipper 60 is provided in the disclosed example, other material fasteners could be utilized within the scope and contemplation of this disclosure.

Referring to FIGS. 8, 9 and 10 with continued reference to FIG. 6, the platform 24 includes a base 66 having an inner foam portion 70 surrounded by a base liner 68. The base liner 68 is sewn such that access is not provided to the foam portion 70. The base liner 68 is formed from mostly waterproof material. The base liner 68 includes at least one side gusset 76 formed from an air permeable, breathable material to provide for the evacuation of air. In this example, the side gusset 76 is provided on a short side of the base 66 and is formed from a breathable polyester fabric. It should be appreciated that other gusset or air permeable features and materials could be utilized with the base liner 68 and are within the contemplation of this disclosure. In one disclosed example, the waterproof material is a polyester fabric. The foam portion 70 is formed from a polyurethane foam material. As appreciated, other materials could be utilized and are within the contemplation and scope of this disclosure.

The top cover 26 includes the top surface 42 that provides the nesting area 42, four sides and a partial bottom portion with the opening 64 (FIG. 6). The bottom cover 28 includes a corresponding opening 54. Top and bottom portions 36, 38 of the cover zipper 30 are disposed about an opening periphery 72 of each of the openings 54, 64. The opening periphery 72 is inset from the outer periphery 32 of the platform 24. The bottom portion 38 of the cover zipper 30 is disposed around the opening 54 and the top portion 36 of the cover zipper 30 is disposed about the opening 64.

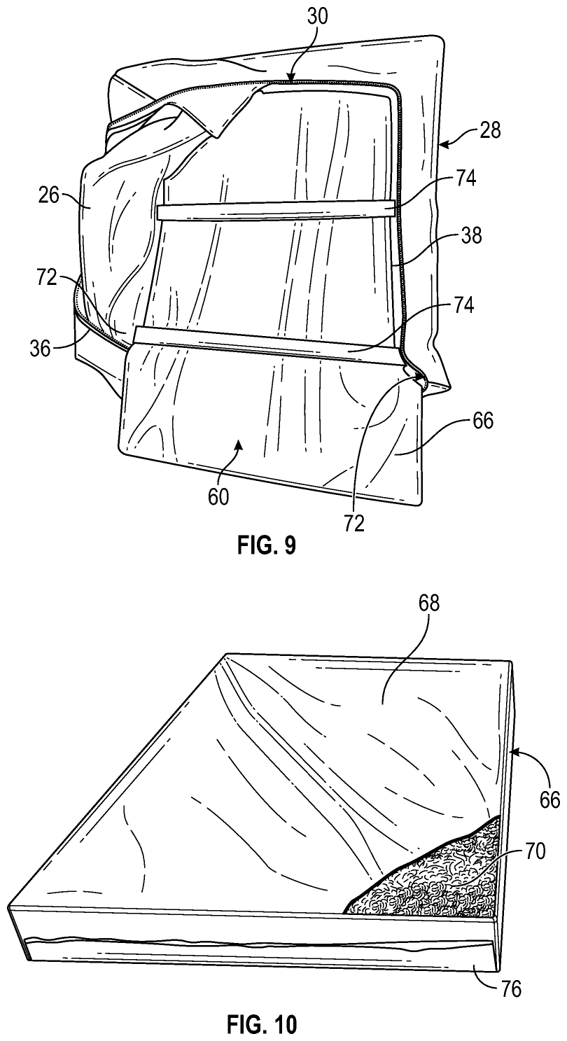

Sides of the bottom opening 54 by at least one elastic strap 74. The elastic straps 74 pull inward to maintain the inset configuration of the bottom opening 54. In this example, two elastic straps 74 extend across sides of the opening 54 in the bottom cover 28. The elastic straps 74 exert a biasing tension to prevent the top and bottom covers 26, 28 from losing the desired shape. Moreover, the elastic straps 74 maintain the inset configuration that hides the cover zipper 30 from the family pet. The example elastic straps 74 are disposed across the long ends of the platform 24. Additional straps 74 may be installed to further maintain and hold the desired original shape. The elastic straps 74 are sewn into an edge material that also accommodates the bottom zipper 38. The elastic straps 74 can be stretched sufficiently to provide for complete removal of the bottom cover 28 from the base 66. FIG. 9 shows partial removal of the bottom cover 28 from the base 66.

As appreciated, the Figures show the top cover 26 still partially attached to the bottom cover 28 by the cover zipper 30. The pillow insert 44 and the base 66 can both be removed without complete detachment of the top cover 26 from the bottom cover 28. However, the cover zipper 30 provides for complete detachment of the covers 26, 28 for care and washing.

The disclosed pillow top pet bed 20 includes features that simplify care and clean up for the pet owner while also providing an adjustable top pillow for tailoring firmness to provide both comfort and a feeling of well-being for a family pet.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. An adjustable comfort pet bed comprising:
a pillow top including a pillow insert and a top cover;
a platform including a base and a bottom cover; and
a cover fastener attaching the top cover to the bottom cover.

2. The pet bed as recited in claim 1, wherein the pillow insert is filled with a fill material.

3. The pet bed as recited in claim 2, wherein the pillow insert includes a top side attached to a bottom side at a seam and an inner cavity disposed between the top side and bottom side, wherein the top side is waterproof and the bottom side is permeable for providing air flow from the inner cavity.

4. The pet bed as recited in claim 3, wherein the pillow insert includes an insert fastener disposed along a portion of the seam, the insert fastener providing for access to the inner cavity to provide for adjustment of an amount of fill material within the pillow top.

5. The pet bed as recited in claim 4, including at least one zipper flange within the inner cavity proximate the insert fastener for holding fill material away from insert fastener to prevent fouling of the insert fastener.

6. The pet bed as recited in claim 5, including a base liner surrounding the base, wherein the base liner includes at least one waterproof side.

7. The pet bed as recited in claim 6, wherein the top cover includes a bottom opening and a portion of the cover fastener is disposed about a periphery of the bottom opening.

8. The pet bed as recited in claim 7, wherein the bottom cover has a top opening and a portion of the cover fastener is disposed about a periphery of the top opening.

9. The pet bed as recited in claim 8, including at least one strap attached to opposing sides of the top opening in the bottom cover to hold the bottom cover onto the base.

10. The pet bed as recited in claim 9, wherein the cover fastener comprises a zipper with a first portion that is disposed on the top cover about the periphery of the bottom opening and a second portion that is disposed on the bottom cover about the periphery of the top opening.

11. The pet bed as recited in claim 10, wherein the pillow top and the platform include an outer periphery that is substantially the same and the zipper is inset from the outer periphery.

12. The pet bed as recited in claim 11, wherein the at least one strap comprises two straps formed of an elastic material to pull the opposing sides of the top opening in the bottom cover toward each other.

13. The pet bed as recited in claim 1, wherein the bottom cover includes a bottom surface formed from a skid resistant material.

14. The pet bed as recited in claim 2, wherein the fill material comprises a cross-cut memory foam and microfiber.

15. The pet bed as recited in claim 12, wherein the base comprises a foam material.

16. A pillow top pet bed comprising:
a pillow top including a pillow insert and a top cover, the top cover includes a bottom opening;
a platform including a base and a bottom cover, the bottom cover has a top opening, wherein the pillow top and the platform define a common outer periphery; and
a cover zipper disposed about a periphery of the bottom opening and the top opening for attaching the top cover to the bottom cover, wherein the zipper is inset from the common outer periphery.

17. The pillow top pet bed as recited in claim 16, wherein the cover zipper includes a first portion disposed about the bottom opening of the top cover and a second portion disposed about the top opening of the bottom cover.

18. The pillow top pet bed as recited in claim 17, wherein the pillow insert is removable from the top cover and has a top side attached to a bottom side at a seam and an inner cavity disposed between the top side and bottom side, wherein the top side is waterproof and the bottom side is permeable for providing air flow from the inner cavity.

19. A method of caring for a pillow top pet bed comprising:
removing a first top cover from a bottom cover by unzipping a zipper that holds the first top cover to a bottom cover;
caring for the first top cover; and
attaching a second top cover to the bottom cover by zipping the zipper while the first top cover is removed for care.

20. The method as recited in claim 19, including adjusting a fill within a pillow insert to provide a desired nesting for a pet.
